(19) United States
(12) Patent Application Publication
(10) Pub. No.: US 2014/0370383 A1
(43) Pub. Date: Dec. 18, 2014

(54) ETHYLENE COPOLYMER-FLUOROPOLYMER HYBRID BATTERY BINDER

(71) Applicant: E I DU PONT DE NEMOURS AND COMPANY, Wilmington, DE (US)

(72) Inventors: CHONGSOO LIM, Hockessin, DE (US); Daniel P. Fore, Newark, DE (US)

(21) Appl. No.: 14/301,660

(22) Filed: Jun. 11, 2014

Related U.S. Application Data
(60) Provisional application No. 61/834,031, filed on Jun. 12, 2013.

(51) Int. Cl. H01M 4/62; H01M 10/0525; H01M 4/131; H01M 4/525; H01M 4/505

(52) U.S. Cl. CPC H01M 4/623; H01M 4/525; H01M 4/505; H01M 4/131; H01M 10/0525
USPC 429/217; 525/199; 525/194; 524/104; 252/506; 252/182.1

(57) ABSTRACT

Disclosed is a composition comprising an ethylene copolymer and a halogenated polymer, wherein the ethylene copolymer comprises or is produced from repeat units derived from ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; and the composition can further comprise a curing agent to crosslink the ethylene copolymer. The composition is useful as a binder for a lithium ion battery.

### CROSS REFERENCE TO RELATED APPLICATION

This application claims priority to U.S. provisional application Ser. No. 61/834,031, filed Jun. 12, 2013; the entire disclosure of which is incorporated herein by reference.

### FIELD OF THE INVENTION

The invention relates to a binder composition and its use in a secondary battery, such as lithium ion battery.

### BACKGROUND OF THE INVENTION

Since commercial lithium ion batteries were first developed by Sony in the early 1990s, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as desirable alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), an electrolyte and a separator, which work in harmony to interconvert chemical energy into electrical energy reversibly as current flow reverses during charge and discharge processes. Typically electrodes are constructed by applying active material onto a current collector in the presence of a binder that affords cohesion between active materials and their adhesion to the current collector. The binder is commonly combined with carbon black for electrical conductivity. Common active materials for anodes include carbon (graphite) or silicon, and, for cathodes, lithium metal oxides, mixed metal oxides, or metal salts of usually lithium. The current collector for anodes is typically Cu, and for cathodes Al. The electrolyte can be a mixture of organic carbonates containing lithium salts. The organic carbonates can include ethylene carbonate, ethyl methyl carbonate, diethyl carbonate, or combinations thereof. The lithium salts can include LiPF₆, LiBF₄, LiAsF₆, LiClO₄, LiCF₃SO₃, LiN(SO₂CF₃)₂ or combinations thereof. The separator is commonly made from a stretched and thus micro-porous multilayered film of polyethylene, polypropylene or combinations thereof.

Widely used binders comprise homopolymers and copolymers of polyvinylidene fluoride (PVDF), which have gained success as binders for cathodes and anodes in lithium ion battery technology. PVDF and copolymers such as a copolymer of vinylidene fluoride and hexafluoropropylene (p(VDF-HFP)) are also used as polymer electrolytes and separators alone or in combination with other materials. PVDF might have suitable properties for lithium ion battery application such as relatively wide redox window for electrochemical stability, high molecular weight for strong adhesion to current collector and robust cohesion between active materials, high polarity to increase compatibility with polar cathode active material, proper viscosity, and commercial availability in high purity. However, it is sometimes reported that PVDF needs improvement in adhesion, percent active loading, swelling behavior and flexibility. As portable electronics become slimmer and flexible in some cases like wearable electronics, the semicrystallinity of PVDF may become a significant drawback. Additionally, the oxidative stability of PVDF is arguably considered not strong enough to accommodate higher operating voltage needs. Another problem of PVDF is a limited aqueous binder system despite the fact that most of them are synthesized by some aqueous processes. The PVDF polymer in aqueous dispersions or emulsions is in the form of tiny semicrystalline solid particles, which is a significantly different morphology than in N-methyl-2-pyrrolidone (NMP) solution. In order to work as a binder, polymeric chains in PVDF need to be disentangled from each other and appropriately interact with other components in electrode slurry materials. Due to PVDF's high melting point (around 170° C.) aqueous PVDF binders may not go through film forming process effectively in the existing LIB process. Also, additives for the emulsions or dispersions such as surfactants and rheology modifiers can interfere with lithium ion battery action. Although NMP is used as a typical solvent for PVDF, it might need to be deselected at a certain point due to its toxicity. These drawbacks of PVDF can be magnified depending on specific applications.

Japanese patent application JP2012-109143 discloses electrochemical cells including a binder comprising a fluororesin aqueous dispersion and water-soluble polyamideimide resin.

WO2013008564 discloses a polymeric blend for cathode binder that has multimodal particle size distribution measured by dynamic light scattering. At least one of the polymeric particles contains fluoropolymers such as PVDF, P(HFP-VDF), PTFE or combinations of fluoropolymers blended with polyacrylic acids. The cathode made therefrom was reported to show high ion conductivity, good oxidation stability, good cohesion between active material and good adhesion to the current collector.

JP 2012-238488 describes a polymeric blend of acrylic polymer and PVA having an excellent resistance toward electrolyte solutions.

JP 2012-234707 discloses polymeric mixtures of acid-modified polyolefins and dimer acid-based polyamides that show excellent adhesiveness and flexibility.

A blended binder of polyimide and poly(vinylidene fluoride) adopted for a Si anode was described in Japanese patent application JP2012-209219.

WO2012082991 and U.S. Pat. No. 6,723,785 disclose a process for making an aqueous dispersion of nonaqueous soluble material by using an organic solvent and a water-soluble polymer as a dispersant during the milling process.

It is desirable to develop additional binder materials in order to provide improved lithium batteries especially for use in the cathode.

### SUMMARY OF THE INVENTION

This invention provides a blend composition comprising
(a) an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof wherein the polymer contains copolymerized units of 2 to 80 weight % of the comonomer; and
(b) a halogenated (co)polymer such as polyvinyl chloride, polyvinylidene chloride, polytetrafluoroethylene, polyvinylidene fluoride (PVDF), tetrafluoroethylene-hexafluoropropylene copolymers, vinylidene fluoride-hexafluoropropylene copolymers (PVDF-HFP), vinylidene fluoride-tetrafluoroethylene copolymers, tetrafluoroethylene-hexafluoropropylene-vinylidene fluoride terpolymers (THV), tetrafluoroethylene-hexafluoropropylene-vinyl fluoride terpolymers, tetrafluoroethylene-hexafluoropropylene-vinylfluoride terpolymers, vinylidene fluoride-chlorotrifluoroethylene copolymers, ethylene-chlorofluoroethylene copolymers, polyvinyl fluoride (PVF), perfluoroalkoxy polymer resin (PFA), fluorinated ethylene propylene (FEP), poly(ethylene-co-tetrafluoroethylene) (ETFE), polytetrafluoroethylene (PTFE) or combination thereof.

The blend composition may further comprise a metal oxide, mixed metal oxide, metal phosphate, metal salt, or combinations of two or more thereof, and optionally an electrical conductivity aid.

The invention also provides a method for preparing the blend composition above comprising
1) preparing a mixture comprising an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer and an organic solvent;
2) preparing a mixture comprising a halogenated (co)polymer or combination thereof such as polyvinyl chloride, polyvinylidene chloride, polytetrafluoroethylene, polyvinylidene fluoride (PVDF), tetrafluoroethylene-hexafluoropropylene copolymers, vinylidene fluoride-hexafluoropropylene copolymers (PVDF-HFP), vinylidene fluoride-tetrafluoroethylene copolymers, tetrafluoroethylene-hexafluoropropylene-vinylidene fluoride terpolymers (THV), tetrafluoroethylene-hexafluoropropylene-vinyl fluoride terpolymers, tetrafluoroethylene-hexafluoropropylene-vinylfluoride terpolymers, vinylidene fluoride-chlorotrifluoroethylene copolymers, ethylene-chlorofluoroethylene copolymers, polyvinyl fluoride (PVF), perfluoroalkoxy polymer resin (PFA), fluorinated ethylene propylene (FEP), poly(ethylene-co-tetrafluoroethylene) (ETFE), polytetrafluoroethylene (PTFE) and an organic solvent;
3) combining the mixture comprising the ethylene copolymer or combination thereof and the mixture comprising the halogenated (co)polymer or combination thereof.

The method may further comprise mixing the blend composition with a metal oxide, mixed metal oxide, metal phosphate, metal salt, or combinations of two or more thereof, and optionally an electrical conductivity aid.

The composition is useful as a binder composition for use in electrochemical cells such as lithium ion batteries. Accordingly, the invention also provides an electrochemical cell comprising the composition. The electrochemical cell may also comprise a negative electrode (anode), a positive electrode (cathode), an electrolyte and a separator.

### DETAILED DESCRIPTION OF THE INVENTION

All publications, patent applications, patents, and other references mentioned herein are incorporated by reference in their entirety.

Although methods and materials similar or equivalent to those described herein can be used in the practice or testing of the present invention, suitable methods and materials are described herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”. For example, a blend described as consisting essentially of two or more recited polymers does not contain any additional nonrecited polymers, but may contain other nonrecited nonpolymeric components.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers and/or to the amounts of its constituent comonomers such as, for example “a copolymer comprising ethylene and 15 weight % of methyl acrylate”. A description of a copolymer with reference to its constituent comonomers or to the amounts of its constituent comonomers means that the copolymer contains copolymerized units (in the specified amounts when specified) of the specified comonomers.

Ethylene copolymers can be melt or solution blended with high performance polymers such as fluoropolymers like PVDF, which can be designed to form IPNs (interpenetrating networks, Sperling, L. H. “Interpenetrating Polymer Networks: An Overview”, in Interpenetrating polymer networks; Klempner, D., et. al.; Advances in Chemistry; American Chemical Society: Washington, D.C., 1994)) or polymeric blends. Here, the term “hybrid” means either an IPN or polymeric blend made of two or more kinds of polymeric resins and compositions thereof. In an IPN, at least one polymeric component is chemically connected either from its monomer or oligomers to build its polymeric network through other polymeric component. Generally speaking, the IPN will form somewhat better mixed polymeric mixtures compared to conventional polymeric blends.

Upon formation of the hybrid of PVDF and the ethylene copolymer (such as in amounts from 30 to 70 weight % of the binder polymers), physical properties of the electrode such as flexibility and peel strength were found to be improved by noticeable magnitudes. The binder system with higher peel strength may make it possible to design a higher energy density lithium ion battery by reducing binder volume contents and increasing cathode active material loading in the unit space of the cathode structure in the lithium ion battery. Improved flexibility in the electrode will bring about improved processability in folding and assembly of lithium ion battery, which can eventually increase freedom in shapes and structural flexibility.

The ethylene copolymers that form hybrids with PVDF are completely soluble in the typical electrolyte solvent such as Novolyte® 1M LiPF₆ 70-30 EMC-EC simply standing for overnight. Surprisingly, they withstand dissolution in the electrolytes after they form hybrids with PVDF, showing only slightly increased swell index compared to the pure PVDF system. This remarkable behavior still holds even without any dependence on the presence of curing agent or crosslinking in the hybrid system.

The hybrid binder approach can compensate for drawbacks of the individual components. The hybrids of fluoropolymers such as PVDF and ethylene copolymer in various compositions can be easily made by solution or extrusion blending, and can be slightly cured by several curing methods. The ethylene copolymer and PVDF can be crosslinked by diamine curing, which potentially can improve adhesion strength of PVDF and also reduce its stiffness while increasing the molecular weights. This chemically bonded PVDF/ethylene copolymer hybrid may be readily processable in existing lithium ion battery processes, since all resin systems can be applied in the form of either dispersions or NMP solutions. Advantageously, the ethylene copolymer may be selected to maintain excellent chain mobility at the normal drying temperature of LIB processes, which will provide a somewhat better environment for PVDF to extend its polymer chains inside the electrode coating to form a solid binder network. This could solve the problems of existing aqueous binder systems of PVDF and/or PTFE where the binder resin melts at a temperature higher than typical drying temperature of lithium ion battery process. For example, the melting point of PVDF homopolymer is about 170° C., higher than a lithium ion battery's drying temperature of 100 to 140° C. Therefore, emulsified or dispersed particles of PVDF might not flow properly to function as a binder, which may lead to poor film forming, weak binding of active material, poor adhesion to the current collector and ultimately unacceptable lithium ion battery performance. However, if an ethylene copolymer that has melting point from about 70 to about 120° C. is blended with the PVDF, the PVDF particles will have a better local environment to extend their polymeric chains because the melted ethylene copolymer will have lower viscosity and be in an amorphous form that can act as a solvent at those temperatures.

These hybrid binder resins can be dispersed in aqueous media by methods widely used in related arts. First, the binder or its blended mixture is to be dissolved in suitable solvent or mixed solvents. Then, the binder organic solution can be dispersed in aqueous media in the presence of surfactants especially polymeric surfactants.

The ethylene copolymer component of the binder compositions can be a dipolymer, a terpolymer, a tetrapolymer, or combinations thereof. The ethylene copolymer may be a copolymer comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof. In particular, it may be a copolymer having copolymerized units of ethylene and a comonomer selected from vinyl esters and α,β-unsaturated monocarboxylic acid esters wherein the polymer contains copolymerized units of at least 2 weight % of the comonomer. Preferably at least one comonomer in the copolymer is vinyl acetate, an alkyl acrylate and/or an alkyl methacrylate.

When the ethylene copolymer is an ethylene vinyl acetate copolymer, the percentage of copolymerized vinyl acetate units can vary broadly from 2 percent to as much as 40 weight % of the total weight of the copolymer or even higher.

The weight percentage of copolymerized vinyl acetate units in the copolymer will preferably be from 2 to 40 weight %, especially from 10 to 40 weight %. The ethylene/vinyl acetate copolymer preferably has a melt flow rate, measured in accordance with ASTM D-1238 at 190° C. with 2.16 kg mass, of from about 0.1 to about 40 g/10 minutes, and preferably from about 0.3 to about 30 g/10 minutes. The ethylene-containing copolymers useful in the compositions described herein can be modified by methods well known in the art, including chemical reaction by grafting with an unsaturated carboxylic acid or its derivatives, such as maleic anhydride or maleic acid.

A mixture of two or more different ethylene/vinyl acetate copolymers can be used in place of a single copolymer as long as the average values for the weight percentage of vinyl acetate comonomer units, based on the total weight of the copolymers, is within the range indicated above. Particularly useful properties may be obtained when two or more properly selected ethylene/vinyl acetate copolymers are used in the binder compositions.

The ethylene copolymer component may also be an ethylene/alkyl (meth)acrylate copolymer. The term “alkyl (meth)acrylate” means alkyl acrylate or alkyl methacrylate or a combination thereof and “ethylene/alkyl (meth)acrylate copolymer” means a thermoplastic copolymer derived from the copolymerization of ethylene and at least one alkyl acrylate or alkyl methacrylate comonomer or a combination thereof, wherein the alkyl group contains from 1 to 8 carbon atoms. Examples of alkyl acrylates suitable for use include, without limitation, methyl acrylate, ethyl acrylate and butyl acrylate and examples of alkyl methacrylates include methyl methacrylate, ethyl methacrylate and butyl methacrylate.

The relative amount of the alkyl (meth)acrylate comonomer incorporated as copolymerized units into the ethylene/alkyl (meth)acrylate copolymer can vary broadly from a few weight percent to as much as 45 weight %, based on the weight of the copolymer or even higher. For example, the alkyl group in the alkyl (meth)acrylate comonomer used to prepare the ethylene copolymer can be from one to 4 carbon atoms. Notably, the level of copolymerized units of alkyl (meth)acrylate comonomer in the ethylene/alkyl (meth)acrylate copolymer is within the range from 5 to 45 weight percent, preferably from 5 to 35 weight %, from 5 to 30, still more preferably from 9 to 28 weight % or 10 to 27 weight % of the total ethylene/(meth)acrylate copolymer, based on the weight of the copolymer. Methyl acrylate (the most polar alkyl acrylate comonomer) can be used to prepare an ethylene/methyl acrylate dipolymer. The methyl acrylate comonomer can be present in a concentration range of from 5 to 30, 9 to 25, or 9 to 24 weight %, of the ethylene copolymer.

The ethylene/(meth)acrylate copolymer preferably has a melt flow rate, measured in accordance with ASTM D-1238 at 190° C. with 2.16 kg mass, from about 0.1 to about 40 g/10 minutes, and preferably from about 0.3 to about 30 g/10 minutes.

Mixtures of ethylene/alkyl(meth)acrylate copolymers may also be used, so long as the level of copolymerized units of (meth)acrylate is within the above-described range, based on the total weight of copolymer present.

A mixture of two or more ethylene copolymers can be used as component (a) in the compositions in place of a single copolymer. Particularly useful properties may be obtained when two properly selected ethylene/alkyl acrylate copolymers are used in blends. For example but not limitation, compositions include those wherein the ethylene/alkyl acrylate component comprises two different ethylene/methyl acrylate copolymers. Also for example, one may replace a single EMA grade in a blend with an equal amount of a properly selected mixture of two EMA grades, where the mixture has the same weight percent methyl acrylate content and melt index as the single EMA grade replaced. By combining two different properly selected EMA copolymer grades, modification of the properties of the composition may be achieved as compared with compositions containing only a single EMA resin grade.

Ethylene copolymers suitable for use herein can be produced by any process, including processes that involve use of a tubular reactor or an autoclave. Copolymerization processes conducted in an autoclave may be continuous or batch processes. In one such process, disclosed in general in U.S. Pat. No. 5,028,674, ethylene, the alkyl acrylate, and optionally a solvent such as methanol and/or a telogen such as propane to control the molecular weight, are fed continuously into a stirred autoclave such as the type disclosed in U.S. Pat. No. 2,897,183, together with an initiator. Ethylene/alkyl acrylate copolymers produced using an autoclave process can be obtained commercially, for example from Exxon/Mobil Corp, and/or from Elf AtoChem North America, Inc.

As generally recognized in the art, a tubular reactor copolymerization technique will produce a copolymer having a greater relative degree of heterogeneity along the polymer backbone (a more blocky distribution of comonomers), will tend to reduce the presence of long chain branching and will produce a copolymer characterized by a higher melting point than one produced at the same comonomer ratio in a high pressure stirred autoclave reactor. Tubular reactor produced ethylene/(meth)acrylate copolymers of this nature are commercially available from E.I. du Pont de Nemours and Company (DuPont), Wilmington, Del. under the Elvaloy® AC tradename.

The ethylene copolymer may also include at least one comonomer such as an epoxide-containing monomer or an α,β-unsaturated dicarboxylic acid or its derivative. An epoxide-containing monomer can include glycidyl methacrylate, glycidyl acrylate, or combinations thereof. An example is an ethylene glycidyl methacrylate copolymer. An α,β-unsaturated dicarboxylic acid or its derivative can include maleic acid, fumaric acid, itaconic acid, a C₁-C₄ alkyl monoester of maleic acid, a C₁-C₄ alkyl monoester of fumaric acid, a C₁-C₄ alkyl monoester of itaconic acid, acid anhydride, or combinations of two or more thereof. An example is a copolymer comprising copolymerized units of ethylene and monoethyl maleic acid ester.

Terpolymers or higher order copolymers may also be used. For example, ethylene, vinyl ester or an α,β-unsaturated ester and maleic anhydride, glycidyl methacrylate or carbon monoxide can be copolymerized to form terpolymers such as ethylene/methyl acrylate/maleic anhydride, ethylene/butyl acrylate/glycidyl methacrylate (EBAGMA), ethylene/butyl acrylate/carbon monoxide (EBACO) or ethylene/vinyl acetate/carbon monoxide (EVACO).

Notably, the ethylene copolymer is an ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof.

Ethylene copolymers with higher alkyl acrylate content, for example, greater than 45 weight % are elastomeric. Thus, elastomeric copolymers include a copolymer derived from copolymerization of

(a) from 13 to 50 weight % of ethylene;

(b) from 50 to 80 weight % of an alkyl acrylate; and

(c) from 0 to 7 weight % of a monoalkyl ester of 1,4-butene-dioic acid, wherein all weight percentages are based on total weight of components (a) through (c) in the copolymer.

The copolymer may contain monoalkyl esters of 1,4-butene-dioic acid moieties that function as cure sites at a loading from about 0.5 to 7 weight percent of the total copolymer (more preferably from 1 to 6 weight % and still more preferably from 2 to 5 weight %).

Thus, a preferred copolymer is derived from copolymerization of from 15 to 50 weight % of ethylene; from 50 to 80 weight % of an alkyl acrylate; and from 2 to 5 weight % of a monoalkyl ester of 1,4-butene-dioic acid.

Preferably the alkyl acrylate has from 1 to 8 carbon atoms in the alkyl group, preferably from 1 to 4 carbon atoms. Alternatively a mixture of alkyl acrylates may be used.

For example, a first alkyl acrylate is either methyl acrylate or ethyl acrylate and the second (and different) alkyl acrylate has from 4 to 8 carbon atoms, such as butyl acrylate. Preferably the total acrylate content comprises from about 50 to 75 weight percent of the copolymer (more preferably from 50 to 70 weight %).

The elastomeric copolymers may have number average molecular weight from about 40,000 to about 65,000 and melt indices from about 1 to about 6 g/10 minutes.

As indicated above, the composition includes random copolymers comprising ethylene and at least one alkyl acrylate, with or without an acid cure site. The alkyl acrylates have up to 8 carbon atoms in the pendent alkyl chains, which can be branched or unbranched. For example, the alkyl groups may be selected from methyl, ethyl, n-butyl, iso-butyl, hexyl, 2-ethylhexyl, n-octyl, iso-octyl, and other alkyl groups. Thus, the alkyl acrylates used in the preparation of the copolymers may be selected from methyl acrylate, ethyl acrylate, n-butyl acrylate, iso-butyl acrylate, hexyl acrylate, 2-ethylhexyl acrylate, n-octyl acrylate, iso-octyl acrylate, and other alkyl acrylates containing up to 8 carbon atoms in the alkyl groups. Preferably, when two or more alkyl acrylates are used, methyl acrylate or ethyl acrylate is used as the first alkyl acrylate and the second alkyl acrylate has from 2 to 8, more preferably 4 to 8, carbon atoms in the alkyl group (when ethyl acrylate is used as the first alkyl acrylate, the second alkyl acrylate has from 3 to 8, more preferably from 4 to 8, carbon atoms in the alkyl group). Notable combinations of alkyl acrylates include combinations of methyl acrylate and a second alkyl acrylate selected from the group consisting of ethyl acrylate, n-butyl acrylate, iso-butyl acrylate, 2-ethylhexyl acrylate, and n-octyl acrylate. Methyl acrylate with n-butyl acrylate and methyl acrylate with 2-ethylhexyl acrylate are preferred combinations.

Small amounts of other comonomers as generally known in the art can be incorporated into the copolymer. Thus for example, it is contemplated that small amounts (a few percent) of alkyl methacrylate comonomer can be used in addition to the alkyl acrylate. Alternatively, an alkyl methacrylate can be used to substitute for the second alkyl acrylate.

The copolymer may contain no cure site component, or higher copolymers may contain 1,4-butene-dioic acid moieties and anhydrides and monoalkyl esters thereof that function as acid cure sites. Of note are acid cure sites that comprise from about 0.5 to about 7 weight %, preferably from 1 to 6 weight %, more preferably from 2 to 5 weight %, of a monoalkyl ester of 1,4-butene-dioic acid, in which the alkyl group of the ester has from 1 to 6 carbon atoms, in the final copolymer. The 1,4-butene-dioic acid and esters thereof exist in either cis or trans form prior to copolymerization, i.e. maleic or fumeric acid. Monoalkyl esters of either are satisfactory. Methyl hydrogen maleate, ethyl hydrogen maleate (EHM), and propyl hydrogen maleate are particularly satisfactory; most preferably EHM is to be employed.

As such, ethylene represents essentially the remainder of the copolymer relative to the required alkyl acrylates and the optional monoalkyl ester of 1,4-butene-dioic acid; i.e., polymerized ethylene is present in the copolymers in a complementary amount.

Examples of copolymers include copolymers of ethylene (E) and methyl acrylate (MA), and copolymers of ethylene (E), methyl acrylate (MA) and ethyl hydrogen maleate (EHM) (E/MA/nBA/EHM).

Copolymers with or without acid cure sites can be readily prepared by copolymerizing ethylene and alkyl acrylate(s) in the presence of a free-radical polymerization initiator including for example peroxygen compounds or azo compounds.

Elastomeric ethylene alkyl acrylate copolymers of this type are commercially available under the Vamac® tradename from DuPont.

The second component of the blend composition may be a halogenated (co)polymer, preferably a fluorinated (co)polymer. As used herein, halogenated or fluorinated (co)polymers are those (co)polymers comprising, in copolymerized form, at least one (co)monomer having at least one halogen atom or at least one fluorine atom per molecule, preferably at least two halogen atoms or at least two fluorine atoms per molecule.

Examples of halogenated polymers include polyvinyl chloride, polyvinylidene chloride, polytetrafluoroethylene, polyvinylidene fluoride (PVDF), tetrafluoroethylene-hexafluoropropylene copolymers, vinylidene fluoride-hexafluoropropylene copolymers (PVDF-HFP), vinylidene fluoride-tetrafluoroethylene copolymers, tetrafluoroethylene-hexafluoropropylene-vinylidene fluoride terpolymers (THV), tetrafluoroethylene-hexafluoropropylene-vinyl fluoride terpolymers, tetrafluoroethylene-hexafluoropropylene-vinylfluoride terpolymers, vinylidene fluoride-chlorotrifluoroethylene copolymers, ethylene-chlorofluoroethylene copolymers, polyvinyl fluoride (PVF), perfluoroalkoxy polymer resin (PFA), fluorinated ethylene propylene (FEP), poly(ethylene-co-tetrafluoroethylene) (ETFE), polytetrafluoroethylene (PTFE).

Notable fluoropolymers include polyvinylidene fluoride (PVDF), polyvinyl fluoride (PVF), perfluoroalkoxy polymer resin (PFA), fluorinated ethylene propylene (FEP), poly(ethylene-co-tetrafluoroethylene) (ETFE), tetrafluoroethylene-hexafluoropropylene-vinylidene fluoride terpolymer (THV), tetrafluoroethylene-hexafluoropropylene-vinyl fluoride terpolymer, vinylidene fluoride-hexafluoropropylene copolymer (PVDF-HFP), polytetrafluoroethylene (PTFE) or vinylidene fluoride-tetrafluoroethylene copolymer. Polyvinylidene fluoride is of particular note.

The functions of a binder in an electrode of lithium ion battery can involve adhesion to the current collector and cohesion between active materials, which are known to be dependent on molecular weight of the binder. The higher the molecular weight of the binder the stronger the adhesion and the cohesion. Since trends in lithium ion battery moves toward slimmer and more flexible structures, the role of the binder to accommodate functional needs becomes even more demanding. The compositions described herein provide improved adhesion over previous binder materials.

Of note is a binder comprising a copolymer derived from copolymerization of
(a) from 13 to 50 weight % of ethylene;
(b) from 50 to 80 weight % of an alkyl acrylate; and
(c) from 0 to 7 weight % of a monoalkyl ester of 1,4-butene-dioic acid, wherein all weight percentages are based on total weight of components (a) through (c) in the copolymer.

It may be desirable to use multifunctional additives with an ethylene copolymer to build up its molecular weight, which can be readily achieved in existing lithium ion battery drying and annealing processes. Examples of multifunctional additives can include trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, pyromellitic anhydride, benzophenone tetracarboxylic anhydride, ethylene glycol bistrimellitate, glycerol tristrimellitate, alkylstyrene-maleic anhydride copolymer, polyazelaic polyanhydride, polyetheramines such as JEFFAMINE®, 1,2,4-benzenetricarboxylic anhydride, bisphenol A, bisphenol A esters, bisphenol A diglycidyl ethers, trimethylolpropane tris[poly(propylene glycol), amine terminated]ether, polyamide made from fatty dimer acid such as VERSAMID®, polyamines, triethylenediamine, 2,4,6-tris(dimethylaminomethyl)phenol, liquid polymercaptan, and polysulfide resin, various kinds of carbodiimides including their derivatives, and various isocyanides including their derivatives. Preferred additives include diamine, diepoxide, dianhydride, carbodiimide, isocyanide, polyamine, polyepoxide or polyanhydride types.

When the ethylene copolymer contains acid cure sites, it can be crosslinked by forming covalent bonds. Crosslinking involves curing the compounded composition, often at elevated temperature, for sufficient time to crosslink the copolymer. The term “vulcanization” is sometimes used to describe this process but vulcanization suggests that heat is required, so “crosslinking” is used herein. For acid-containing copolymers disclosed herein the crosslinking process can be conducted over a broad temperature range of about 0 to about 160° C. Ambient temperatures of 20 to 25° C. can be used, but optionally heat may be applied to facilitate curing.

For example, a blend of the un-crosslinked ethylene copolymer and a curing agent, halogenated polymer, optionally including fillers, other additives and/or other polymers can be subject to a curing step at sufficient time and temperature, such as at about 90 to about 160° C. and for a time of about 3 to about 10 hours or longer, to achieve covalent chemical bonding (i.e., crosslinking). Additional curing and annealing can be done during a lithium ion battery's typical drying process. For example, a crosslinked ethylene copolymer may start to be formed and cured using known procedures at about 90° C. to about 140° C. for about 60 minutes. Post-cure/annealing heating may be conducted at about 90° C. to about 120° C. for several hours. Fillers and additives may include metal oxides, mixed metal oxides, metal phosphates, metal salts, or combinations of two or more thereof, and optionally an electrical conductivity aids as described below.

Useful curing or crosslinking agents include diamines or multifunctional amines. The amine function can include at least one primary amine, secondary amine, tertiary amine, polyamine, or combinations of two or more thereof. An example of a small diamine that may be used is hexamethylene diamine. Amino compounds that aggregate in situ thereby providing polyamine functionality can be used. Oligomeric polyamines and other organic molecules containing more than one amine group can also be used. An oligomeric polyamine can have a high molecular weight and may include about 2 to about 100 amine groups. In applications where extraction or other loss of a small diamine could occur, the high molecular weight polyamine remains to crosslink the acidic copolymer.

The binder compositions may contain from about 1 to about 80 weight % of ethylene copolymer, preferably from about 5 to about 80 weight %, more preferably from about 15 to about 40 weight % of the combination of (a) and (b). Notable compositions include those with about 25 to about 75 weight % of ethylene copolymer, based on the combination of (a) and (b).

To produce a binder for LIB cathodes, an ethylene copolymer or a crosslinked ethylene copolymer can be combined with a single solvent or at least two component solvents, one of which would be relatively nonpolar and the other would be relatively polar in order to form a stable solution and/or concentrate. As an example but not limitation, nonpolar solvents for this application may have fairly low dielectric constant to break down crystallinity caused by polyethylenic structure. Examples of suitable nonpolar solvents are diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane and decaline. Relatively polar solvents may be used to accommodate relatively more polar polymeric materials. Useful polar solvents include acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N,N-dimethyl acetamide, N,N-diethyl acetamide. Notable solvents include ethyl acetate and N-methyl-2-pyrrolidone.

A typical method to make binder solutions or concentrates is to place a pellet, granular or powder form of the ethylene copolymer resin in a single solvent or mixed solvent of nonpolar and polar solvents as described above. When a mixture is used, the ratio of nonpolar solvent to polar one may be from 40:60 to 90:10, preferably from 40:60 to 80:20. The weight percent of polymer in the solution can be from 0.01 weight % to 40 weight %, typically from 5 weight % to 15 weight %. Mechanical stirring or homogenizing is recommended to fully disperse the binder at room temperature or typically under elevated temperatures of about 40 to about 100° C. Heating of the binder solution above 100° C. is discouraged due to thermal sensitivity of some functional groups on ethylene copolymer.

Solutions of halogenated polymers such as polyvinylidene fluoride (PVDF), polyvinyl fluoride (PVF), perfluoroalkoxy polymer resin (PFA), fluorinated ethylene propylene (FEP), poly(ethylene-co-tetrafluoroethylene) (ETFE), tetrafluoroethylene-hexafluoropropylene-vinylidene fluoride terpolymer (THV), tetrafluoroethylene-hexafluoropropylene-vinyl fluoride terpolymer, vinylidene fluoride-hexafluoropropylene copolymer (PVDF-HFP), polytetrafluoroethylene (PTFE) or vinylidene fluoride-tetrafluoroethylene copolymer in organic solvents can be prepared similarly.

The ethylene copolymers, a halogenated (co)polymer such as PVDF, PVF, PFA, FEP, ETFE, THV, PVDF-HFP, PTFE or other similar polymers can generally be combined, dissolved, or dispersed, by any means known to one skilled in the art, in one or more of the solvents illustrated above to produce a slurry composition.

For example, a method for preparing the blend composition may comprise
(1) preparing a mixture of an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer in an organic solvent;
(2) preparing a mixture of a halogenated (co)polymer or combination thereof such as PVDF, PVF, PFA, FEP, ETFE, THV, PVDF-HFP, PTFE or other similar polymers in an organic solvent;
(3) combining the mixture of the ethylene copolymer and the mixture of the halogenated (co)polymer.

If necessary, the resin or resin mixture solution may be converted into an aqueous dispersion by techniques known to related arts by adding the organic solutions into surfactant-containing aqueous media with proper means of mixing. After formation of the aqueous dispersion, the solvent used in dissolving the resins can be removed by distillation or filtered through a micromembrane. However, sometimes the solvent can be retained. The amount of solvent can be adjusted such that the resulting slurry composition has a viscosity suitable for binding the binder composite to a cathode active material, or an electroconductivity supplying agent, used for the cathode. Examples of other binders include an ethylene (meth)acrylic acid copolymer, a lithium neutralized ethylene (meth)acrylic acid copolymer, a cellulose polymer, a polyacrylonitrile or polymethacrylonitrile. The preferred weight percent of hybrid mixture of the ethylene copolymer and fluoropolymer in the solution/dispersion can be from 0.01 weight % to 40 weight %, typically from 1 weight % to 25 weight %.

Alternatively, the binder blends can be prepared by conventional coextrusion of each component resin that may or may not include partial reactions during the mixing.

The method for preparing a battery binder composition may further comprise mixing the blend composition with a metal oxide, mixed metal oxide, metal phosphate, metal salt, or combinations of two or more thereof, and optionally an electrical conductivity aid.

An electrode can comprise a metal oxide, mixed metal oxide, metal phosphate, metal salt, or combinations of two or more thereof and a binder composition wherein the binder composition can be as described above. The blend composition may further comprise a metal oxide, mixed metal oxide, metal phosphate, metal salt, or combinations of two or more thereof, and optionally an electrical conductivity aid.

The cathode active material in the slurry composition can be any one known to one skilled in the art. Suitable cathode materials for a lithium ion battery include without limitation lithiated transition metal oxides such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.20}O₂, Li_{1+z}Ni_{1-x-y}CoₓAl_{y}O₂ where 0<x<0.3, 0<y<0.1, 0<z<0.06; high voltage spinels such as LiNi_{0.5}Mn_{1.5}O₄ and those in which the Ni or Mn are partially substituted with other elements such as Fe, Ga, or Cr; lithiated transition metal phosphates such as LiFePO₄, LiMnPO₄, LiCoPO₄, LiVPO₄F; mixed metal oxides of cobalt, manganese, and nickel such as those described in U.S. Pat. Nos. 6,964,828 and 7,078,128; nanocomposite cathode compositions such as those described in U.S. Pat. No. 6,680,145; lithium-rich layered composite cathodes such as those described in U.S. Pat. No. 7,468,223; and cathodes such as those described in U.S. Pat. No. 7,718,319 and the references therein. Other non-lithium metal compounds can include transition metal sulfides such as TiS₂, TiS₃, MoS₃ and transition metal oxides such as MnO₂, Cu₂V₂O₃, amorphous V₂OP₂O₅, MoO₃, V₂O₅, and V₆O₁₃.

The anode active material in the slurry composition can be any one known to one skilled in the art. Anode active materials can include without limitation carbon materials such as carbon, activated carbon, graphite, natural graphite, mesophase carbon microbeads; lithium alloys and materials which alloy with lithium such as lithium-aluminum alloys, lithium-lead alloys, lithium-silicon alloy, lithium-tin alloy, lithium-antimony alloy and the like; carbon materials such as graphite and mesocarbon microbeads (MCMB); metal oxides such as SnO₂, SnO and TiO₂; and lithium titanates such as Li₄Ti₅O₁₂ and LiTi₂O₄. In one embodiment, the anode active material is lithium titanate or graphite.

Electrical conductivity aids may be also added to the slurry to reduce the resistance and increase the capacity of the resulting electrode. Suitable conductivity aids include without limitation acetylene black, furnace black, carbon fibers and nanotubes.

A cathode active material or the anode active material can be combined with the slurry by any means known to one skilled in the art. The cathode active material or anode active material can be present in the binder composite from 0.1 to 80, 0.5 to 70, or 1 to 60 weight % of the total final composition.

The slurry composition comprising the ethylene copolymer and fluoropolymer or the electrode composition comprising the slurry composition and the cathode active material (or anode active material) can be mixed by any means known to one skilled in the art such as, for example, using a ball mill, sand mill, an ultrasonic disperser, a homogenizer, or a planetary mixer.

The composition is useful as a binder composition for use in electrochemical cells such as lithium ion batteries. Accordingly, the invention also provides an electrochemical cell comprising the composition. The electrochemical cell may also comprise a negative electrode (anode), a positive electrode (cathode), an electrolyte and a separator. Other components of a battery may include a current collector.

An electrochemical cell, battery or lithium ion battery can be produced by any means known to one skilled in the art. Materials for the anode and cathode may include the compositions described above.

Any current collector known to one skilled in the art can be used. For example, metals such as iron, copper, aluminum, nickel, and stainless steel can be used. A slurry composition containing the cathode active material or the anode active material disclosed above can be applied or combined onto a current collector followed by drying the slurry and bonding the resultant electrode layer comprising the binder cathode active material or anode active material. Drying can be carried out by any means known to one skilled in the art such as drying with warm or hot air, vacuum drying, infrared drying, or dried with electron beams. The final dry binder layer can be in the range of about 0.0001 to about 6 mm, 0.001 to 5 mm, or 0.005 to 2 mm. Applying a slurry onto a current collector can be carried out by any means known to one skilled in the art such as, for example, using doctor blade, dipping, reverse roll, direct roll, gravure, or brush-painting.

An electrolyte may be in a gel or liquid form if the electrolyte is an electrolyte that can be used in a lithium ion battery. A representative electrolyte is a mixture of ethyl methyl carbonate and ethylene carbonate, typically comprising a lithium salt dissolved in solvent. Known salts include LiClO₄, LiBF₄, LiPF₆, LiCF₃CO₂, LiB(C₂O₄)₂, LiN(SO₂CF₃)₂ LiAsF₆, or LiSbF₆.

### EXAMPLES

### Materials

NMC: Lithium Nickel Manganese Cobalt Oxide having a nominal formula of Li_{1.05}Ni_{0.33}Mn_{0.33}Cu_{0.33}O₂, commercially available under the code NM-1101 from Toda America, Battle Creek, Mich., Lot 7711206.
Carbon black: Super C65, commercially available from Timcal, Westlake, Ohio, Batch 555.
ECP-1: an ethylene copolymer containing 63 weight % of methyl acrylate and 4.7 weight % of ethyl hydrogen maleate, the remainder ethylene, used as 10 weight % solution in NMP.
ECP-2: an ethylene copolymer containing 55 weight % of methyl acrylate and 2.0 weight % of ethyl hydrogen maleate, the remainder ethylene.
ECP-3: an ethylene copolymer containing 23 weight % methyl acrylate, 41 weight % of butyl acrylate and 3.2 weight % of ethyl hydrogen maleate, the remainder ethylene.
PVDF: a polyvinylidene difluoride available commercially under the tradename Kynar® HSV900 from Arkema.
Al foil is 1 mil aluminum foil from Allfoils.
NMP: N-Methyl-2-pyrrolidone, commercial grade.
IPA: isopropyl alcohol commercial grade.
DCM: dichloromethane commercial grade.

### Electrolyte: Novolyte® 1M LiPF₆ 70-30 EMC-EC.

### Procedures for Blending Resins

A mixture of two parts of ECP-1 and three parts PVDF were mixed together in a melt-blending torque rheometer. The polymer blend was mixed at 125 rpm with a thermal set point of 120° C. It was observed that a significant amount of heat was generated as the polymers mixed together, where internal temperatures increased to over 165° C. before torque readings stabilized. When the polymer mixture was removed, it was immediately pressed at 180° C. into a thin film which appeared to have a high degree of uniformity. An unpressed portion of this mixed polymer was placed in NMP solution at 5 weight %, which stayed clear for several weeks (Solution A).

Alternatively, a ratio of 3 parts of PVDF and 2 parts of ECP-1, both at 5-10 weight % in NMP solution, were blended by a rotor-stator (model PT 10-35 GT, 7.5 mm dia. stator, Kinematicia, Bohemia, N.Y.) to afford a transparent solution of the polymer blend (Solution B) which developed a phase separation after standing overnight at ambient temperature. A similar solution blend of 5 weight % of 3 parts of PVDF and 2 parts of ECP-1 was obtained by using ethyl acetate rather than NMP (Solution C).

Films generated from each polymeric solution were examined under scanning electron microscopy. The films prepared from three different methods exhibited a homogeneously well-mixed appearance even at 100 nm scale magnification.

### General Procedure for Cathode Paste Formulation

All parts disclosed here are by weight. Carbon black, a first portion of solvent, and binder solution were combined in a vial and mixed using a planetary centrifugal mixer (ARE-250, Thinky USA, Inc., Laguna Hills, Calif.) at 2000 rpm for 2 minutes. NMC and additional amount of solvents were added and the slurry again centrifugally mixed at 1000 rpm for 2 minutes. The mixture was further homogenized using a rotor-stator (model PT 10-35 GT, 7.5 mm dia. stator, Kinematicia, Bohemia, N.Y.) briefly at 1500 rpm and then 5 minutes at 5000 rpm. During homogenization, the temperature of the vial was kept below 60° C., cooling with an ice bath if needed. The vial was secured in a clamp and manually moved about the disperser shaft for the duration of the homogenization. Finally the slurry was centrifugally mixed again at 2000 rpm for two minutes followed by degassing at 100 rpm for 1 min.

### General Procedure for Cathode Paste Casting, Calendaring and Preparation of Coin Cells

Using a doctor coater, each test slurry was uniformly applied on the surface of lithium ion battery grade Al foil (1 mil=25.4 micron thickness) that was pre-cleaned with isopropyl alcohol and dichloromethane and dried by air blow to facilitate adhesion. The slurry (i.e., dispersion of cathode active material, carbon black, and binder in a solvent) coated cathode was dried in a convection oven (model FDL-115, Binder Inc., Great River, N.Y.) for an hour while ramping the oven set temperature from 60° C. to 120° C. The resulting 51-mm wide cathode was placed between 125-μm thick brass sheets and passed through a calendar three times using 100 mm diameter steel rolls at ambient temperature with nip forces increasing in each of the passes, starting at 1250 psi with the final pass at 1750 psi. An example cathode paste composition was prepared using the materials summarized in Table 1, and it has 13.99 mg NMC/cm² of the cathode.

TABLE 1

| | Weight (g) | Solid (g) |
|---|---|---|
| Carbon black | 0.421 | 0.421 |
| NMC | 6.021 | 6.021 |
| NMP | 6.910 | |
| ECP-1/PVDF/NMP (10%) | 2.521 | 0.252 |
| curing agent (1%) | 0.254 | 0.00254 |
| Total | 16.127 | 6.697 |

Cathode disks were punched out by using a 0.5-inch diameter arch punch, and were further dried overnight in a dry-box antechamber under vacuum at 90° C. After 18 hours, inside an argon-filled dry box, non-aqueous electrolyte lithium-ion CR2032 coin cells were prepared for electrochemical evaluation. The coin cell parts (case, spacer, wave spring, gasket, and lid) and coin cell crimper were obtained from Hohsen Corp (Osaka, Japan). The anodes were lithium metal (275 μm thick, Chemetall Foote, Kings Mountain, N.C.) and the separator was a microporous polyolefin (CG2325, Celgard, LLC. Charlotte, N.C.). The electrolyte was ethyl methyl carbonate (70 v %)/ethylene carbonate (30 v %)/1 M LiPF₆ (Novolyte Purolyte® A2 Series, BASF, Independence, Ohio).

### Electrochemical Evaluation

Using the procedure described above, a coin cell with active loading of 13.99 mg NMC/cm² was assembled from a blend of PVDF and ECP-1 as in Table 1. Also prepared are a similar cell designated “V” prepared using ECP-1 as a binder and cells designated “F1” and “F2” prepared using PVDF as a binder. The coin cells were evaluated using a commercial battery tester (Series 4000, Maccor, Tulsa, Okla.) at ambient temperature and cycling between voltage limits of 3.0 to 4.3 V. First the cells were cycled five times for formation and to determine their initial capacity. Charging was by CC-CV, using a constant current (CC) charge at 28 mA per g of cathode active material to the upper voltage cutoff, followed by a constant voltage (CV) step holding the voltage at the upper limit until the current decayed to 14 mA/g. Discharge was by CC at 28 mA/g. The coulombic efficiency (CE) of each of the five cycles was calculated as

CE=discharge capacity/charge capacity.

The discharge capacities and the CE's in the first five cycles are reported in Table 2.

TABLE 2

| | Discharge Capacity (mAh/g) | | | | Coulombic Efficiency (%) | | | |
|---|---|---|---|---|---|---|---|---|
| | PVDF- | | | | PVDF- | | | |
| | ECP-1 | | | | ECP-1 | | | |
| Cycle | Blend | V | F1 | F2 | Blend | V | F1 | F2 |
| 1 | 135.9 | 119.4 | 133.8 | 136.4 | 80.78 | 79.75 | 82.53 | 83.00 |
| 2 | 136.1 | — | — | — | 99.64 | — | — | — |
| 3 | 135.5 | — | — | — | 99.04 | — | — | — |
| 4 | 134.9 | — | — | — | 98.89 | — | — | — |
| 5 | 135.5 | 128.0 | 136.1 | 136.0 | 99.16 | 98.75 | 98.66 | 98.81 |

All cells performed similarly in this test.

Second, a discharge rate test with seven charge-discharge cycles was performed using constant current discharges at 14, 42, 140, 280, 700, 1400, and finally 2800 mA/g. Third, the cells were charged and subjected to a voltage-hold test (“floating voltage” or “leak test”) in which the voltage was held constant for 200 hours at ambient temperature at 4.3 V while the current was monitored. The average current in the last 50 hours of the voltage-hold test was 5.4×10⁻⁷ amp. Fourth, the cells were again tested for discharge rate capability using the same procedure as above. The capacity in the first and second rate tests, measured at 14 mA/g discharge rate, was compared and used as a measure of capacity loss following the voltage-hold test (first row of Table 3).

C-rate is the reciprocal of the time needed to completely discharge or charge a battery, which is typically expressed as the relative discharge current expressed as a multiple of the numeric value of the discharge capacity measured at the lowest discharge rate of 14 mA/g. Thus if the cell capacity at the lowest discharge rate was 2.8 mAh, 0.1 C was a discharge rate of 0.28 mA and 1 C was a discharge rate of 2.8 mA. The results of the rate tests before and after the voltage hold, shown in Table 3, indicate that the cells were not degraded in capacity or rate capability by the voltage holding test at 4.3 V(Li) for 200 hours.

TABLE 3
Discharge Capacity (mAh/g)

| C-rate | First | Second |
|---|---|---|
| 0.1 | 140.1 | 142.4 |
| 0.3 | 124.4 | 128.7 |
| 1 | 40.3 | 46.5 |
| 2 | 14.2 | 16.2 |
| 4.99 | 0.2 | 0.3 |
| 9.26 | 0.0 | 0.0 |
| 19.11 | 0.0 | 0.0 |

Table 4 show four different coin cells based on two different binder systems: a PVDF and an ECP-PVDF hybrid (PVDF modified with30 weight % of ethylene copolymer ECP-1). The cells were prepared using cathode active material of NMC (Lithium Nickel Manganese Cobalt Oxide (LiNi_{0.333}Mn_{0.333}Co_{0.333}O₂) and carbon black (Super C65, Timcal, Westlake, Ohio) by above described methods. The cells of A1, A2, B1 and B2 were cycled using a commercial battery tester (Series 4000, Maccor, Tulsa, Okla.) at ambient temperature using constant current charging and discharging between voltage limits of 3.0 to 4.25 V at a current of 35 mA per gram of cathode active material (at 0.25 C-rate). The results of testing are summarized in Table 4 (discharge capacity) and Table 5 (coulombic efficiency). Also shown is a similar cell designated “V” prepared using ECP-1 as a binder. They provided capacity of about 135 mAh/g under 4.25 V charge, 3 V discharge and 0.25 C-rate. Although their discharge capacity is smaller than NMC's theoretical value of 160 mAh/g, possibly due to its 0.25 C-rate, they all performed well by showing stable charge-discharge cycles up to 180 in their half cells, even without optimization.

TABLE 4
Discharge Capacity (mAh/g)

| | Coin cell | | | | |
|---|---|---|---|---|---|
| | PVDF | | ECP-1-PVDF | | ECP-1 |
| Cycle | A1 | A2 | B1 | B2 | V |
| 1 | 136.2 | 137.5 | 134.3 | 129.4 | 119.4 |
| 5 | 133.8 | 135.2 | 134.6 | 133.4 | 128.0 |
| 10 | 136.4 | 137.6 | 135.9 | 134.5 | 128.7 |
| 15 | 134.5 | 136.2 | 136.8 | 134.4 | 127.8 |
| 20 | 135.4 | 136.9 | 136.3 | 135.1 | 126.9 |
| 25 | 135.6 | 137.0 | 136.4 | 135.5 | 126.0 |
| 30 | 134.6 | 136.1 | 137.2 | 135.1 | 124.5 |
| 35 | 134.6 | 136.3 | 136.3 | 135.2 | 123.5 |
| 40 | 135.1 | 136.3 | 136.7 | 135.7 | 118.7 |
| 45 | 133.9 | 135.9 | 136.5 | 135.5 | 113.0 |
| 50 | 133.9 | 135.1 | 136.2 | 134.7 | 95.2 |
| 55 | 133.6 | 136.6 | 136.5 | 136.1 | |
| 60 | 132.4 | 134.7 | 136.3 | 135.4 | |
| 65 | 132.5 | 135.0 | 135.7 | 135.0 | |
| 70 | 131.7 | 134.3 | 135.8 | 135.1 | |
| 75 | 131.2 | 134.1 | 133.1 | 133.8 | |
| 80 | 129.6 | 133.9 | 132.7 | 133.9 | |
| 85 | 129.3 | 133.1 | 130.9 | 132.9 | |
| 90 | 128.2 | 131.1 | 129.0 | 132.4 | |
| 95 | 126.8 | 131.6 | 128.8 | 131.7 | |
| 100 | 127.1 | 131.3 | 127.5 | 131.6 | |
| 105 | 126.8 | 131.6 | 126.5 | 131.3 | |
| 110 | 126.8 | 129.7 | 124.6 | 129.5 | |
| 115 | 124.7 | 129.7 | 124.5 | 129.7 | |
| 120 | 124.6 | 129.1 | 121.8 | 126.9 | |
| 125 | 122.5 | 126.8 | 119.0 | 125.2 | |
| 130 | 120.9 | 126.0 | 121.8 | 125.5 | |
| 135 | 121.2 | 126.1 | 121.5 | 125.1 | |
| 140 | 118.5 | 125.8 | 123.3 | 123.5 | |
| 145 | 117.7 | 125.0 | 123.7 | 119.6 | |
| 150 | 115.0 | 125.8 | 122.3 | 123.2 | |
| 155 | 107.8 | 121.4 | 119.1 | 122.3 | |
| 160 | 106.0 | 125.2 | 115.3 | 121.6 | |
| 165 | 106.1 | 122.2 | 108.5 | 119.4 | |
| 170 | 99.8 | 121.1 | 99.4 | 117.5 | |
| 175 | 96.6 | 119.6 | 92.0 | 118.7 | |
| 180 | 87.6 | 116.9 | 71.9 | 110.3 | |

TABLE 5
Coulombic Efficiency (%)

| | Coin cell | | | | |
|---|---|---|---|---|---|
| | PVDF | | ECP-1-PVDF | | ECP-1 |
| Cycle | A-1 | A-2 | B-1 | B-2 | V |
| 1 | 122.15 | 120.81 | 80.20 | 79.70 | 79.75 |
| 5 | 97.08 | 97.14 | 97.36 | 97.55 | 98.75 |
| 10 | 99.46 | 99.08 | 99.04 | 99.24 | 97.89 |
| 15 | 97.87 | 98.16 | 100.58 | 99.76 | 98.13 |
| 20 | 98.62 | 98.77 | 98.32 | 98.39 | 98.07 |
| 25 | 98.80 | 98.64 | 97.51 | 98.59 | 98.05 |
| 30 | 98.43 | 98.68 | 99.05 | 98.51 | 97.90 |
| 35 | 98.16 | 98.60 | 98.00 | 98.12 | 98.39 |
| 40 | 99.53 | 98.76 | 97.78 | 98.76 | 97.73 |
| 45 | 98.50 | 98.82 | 98.17 | 98.63 | 98.34 |
| 50 | 98.72 | 98.46 | 97.85 | 98.03 | 96.40 |
| 55 | 98.99 | 99.86 | 98.18 | 99.27 | |
| 60 | 98.25 | 98.76 | 98.10 | 98.61 | |
| 65 | 98.56 | 98.73 | 97.86 | 97.81 | |
| 70 | 98.59 | 98.80 | 98.41 | 98.96 | |
| 75 | 97.87 | 98.61 | 97.51 | 98.28 | |
| 80 | 98.54 | 99.81 | 97.70 | 98.86 | |
| 85 | 98.49 | 99.06 | 97.94 | 99.18 | |
| 90 | 98.51 | 98.31 | 97.50 | 97.97 | |
| 95 | 97.83 | 99.37 | 98.40 | 98.68 | |
| 100 | 98.97 | 98.67 | 97.77 | 98.40 | |
| 105 | 98.63 | 99.28 | 97.37 | 98.66 | |
| 110 | 98.63 | 98.76 | 98.08 | 98.66 | |
| 115 | 99.02 | 98.90 | 97.70 | 98.29 | |
| 120 | 98.34 | 98.43 | 97.58 | 97.84 | |
| 125 | 98.14 | 98.33 | 97.63 | 98.20 | |
| 130 | 101.08 | 98.94 | 98.74 | 97.79 | |
| 135 | 99.66 | 98.90 | 97.98 | 99.20 | |
| 140 | 96.92 | 99.25 | 98.14 | 97.73 | |
| 145 | 97.40 | 98.61 | 97.16 | 94.89 | |
| 150 | 97.73 | 99.28 | 97.70 | 98.70 | |
| 155 | 94.08 | 95.56 | 97.48 | 97.80 | |
| 160 | 98.15 | 98.12 | 96.47 | 97.23 | |
| 165 | 96.93 | 97.42 | 97.53 | 97.90 | |
| 170 | 95.26 | 96.61 | 98.64 | 97.30 | |
| 175 | 96.43 | 97.37 | 92.94 | 97.49 | |
| 180 | 93.24 | 100.13 | 81.19 | 95.87 | |

Physical Properties of ECP modified PVDF based Electrodes

To evaluate effects of ECP modification on PVDF binder, five formulations were made depending on the weight ratios of ECP resin and PVDF (Table 6). Each binder was preblended by dissolving ECP resin and PVDF with specific weight ratio in NMP and added to the slurry composition in NMP solution forms. Curing agent (hexamethylene diamine) was also added as NMP solution. Each formulation was prepared at the solid loading of about 45% based on the general cathode paste formulation method.

TABLE 6
ECP modified cathode paste formulation

| | Sample | | | | | | | | | |
|---|---|---|---|---|---|---|---|---|---|---|
| | ECP-1 | | ECP-PVDF-1 | | ECP-PVDF-2 | | ECP-PVDF-3 | | PVDF | |
| | Weight % of ECP-1 in blend | | | | | | | | | |
| | 100 | | 70 | | 50 | | 0 | | 0 | |
| | Wt (g) | Wt % | Wt (g) | Wt % | Wt (g) | Wt % | Wt (g) | Wt % | Wt (g) | Wt % |
| Carbon | 0.888 | 4.99 | 0.897 | 5.01 | 0.899 | 5.00 | 0.913 | 5.05 | 0.915 | 5.02 |
| NMC | 16.4 | 92.0 | 16.4 | 91.6 | 16.4 | 91.2 | 16.4 | 90.7 | 16.4 | 90.0 |
| Binder | 0.535 | 3.00 | 0.614 | 3.43 | 0.676 | 3.76 | 0.762 | 4.22 | 0.915 | 5.02 |
| Curing agent | 0.004 | 0.02 | 0.003 | 0.017 | 0.003 | 0.017 | 0.002 | 0.011 | 0 | 0 |
| Total | 17.8 | | 17.9 | | 18.0 | | 18.1 | | 18.2 | |

The bending test was done for the electrodes targeted for a thickness of 50 μm. From each formulation, five samples were made in 1-inch by 4-inch size. Each strip of cathode was placed on a stainless steel wire of 1 mm thickness in perpendicular direction at an angle of 180 for the bending test. The area of bent position of the electrode was observed. A test was given a “Pass” rating if no crack was observed for all five samples. “Fail” was used for electrodes that developed any crack and delamination in any of the five samples (Table 7).

TABLE 7
Bending Test for ECP modified Cathode

| | | ECP- | ECP- | ECP- | |
|---|---|---|---|---|---|
| | ECP-1 | PVDF-1 | PVDF-2 | PVDF-3 | PVDF |
| Thickness (μm) | 76.7 | 62.7 | 66.2 | 53.1 | 54.9 |
| Rating | Fail | Pass | Pass | Pass | Pass |

Flexibility of electrodes was also measured by a three-point flex test that followed IS0178 with 600 gmf load cell to make force measurements with about 0.3 inch (8 mm) span. Five electrodes were fabricated with the thickness of 177 μm after calendaring. Six samples were prepared from each electrode for the test. The modulus was fit in the linear region of the stress-strain curve and the strain formulas are included in the standard. Average values of modulus, stress and strain of the prepared electrodes are in Table 8.

TABLE 8
Three Point Flexibility Test for ECP modified Cathode (ISO178)

| | | ECP- | ECP- | ECP- | |
|---|---|---|---|---|---|
| | ECP-1 | PVDF-1 | PVDF-2 | PVDF-3 | PVDF |
| Thickness (μm) | 174.8 | 179.8 | 174.5 | 173.2 | 161.0 |
| Modulus (10 kpsi) | 3.09 | 1.40 | 1.95 | 2.85 | 2.73 |
| Ultimate Stress (dpsi) | 2.20 | 3.80 | 5.38 | 5.96 | 3.73 |
| Ultimate Strain (%) | 2.48 | 4.63 | 4.75 | 3.03 | 2.28 |
| Remark | un- | — | — | — | — |
| | stable | | | | |

The results in Table 8 show that the hybrid binder systems were more flexible than PVDF alone as indicated by their comparable or lower modulus and clearly higher ultimate stress and strain.

Peel strength of each formulation was obtained based on a modified ASTM D903 method—Standard Test Method for Peel or Stripping Strength of Adhesive Bonds. The thickness of coating for each formulation in Table 6 was adjusted to be 50 μm after drying and calendaring. PSA tape (Interpolymer PA-280630, 1 inch wide and 5.0 mil thick) was applied on the surface of cathode in such a way to generate five samples of 1-inch wide and 4-inch long specimen from the single coated cathode. The end of each specimen can have attached Kapton® film for consistency and effective testing. PSA taped cathode was placed in a manila folder and passed through a rubber-calendared gap using Fellowes Venus 125 Laminator at room temperature. The rubber-calendared cathode was placed in the nitrogen dry box for minimum 24 hours and maximum 48 hours. After cutting specimens into 1 inch and 4 inch sizes by scissor, PSA taped cathode specimen was mounted by attaching the aluminum current collector side on a steel alignment plate. For the mounting, a double sided PSA tape (Interpolymer SCP-054R,3.3 mil thick) was used. Peeling was done at a speed of 50 mm/min at 180° angle on an Instru-met 1122 testing machine with Instron-made load cell having maximum capacity of 10 pounds and MTS Testworks software. Peel strength of a binder reported in Table 9 is the average value of five specimens between 2 to 5 inch displacements.

TABLE 9
Peel Strength of ECP modified Cathode

| | | ECP- | ECP- | ECP- | |
|---|---|---|---|---|---|
| | ECP-1 | PVDF-1 | PVDF-2 | PVDF-3 | PVDF |
| Peel strength (lbf/in) | 0.021 | 0.610 | 1.520 | 2.769 | 1.886 |
| Remark | un- | | | | |
| | stable | | | | |

The results in Table 9 show significant improvement in peel strength of the ECP-modified PVDF binder compared to PVDF alone. The sample with 30 weight % of ECP-1 (ECP-PVDF-3) showed adhesion stronger than either PVDF or ECP-1 alone.

Electrolyte resistance of ECP modified PVDF cathode was tested by blending 30 weight % of ECP resins with PVDF. Three different ECP resins were mixed with PVDF-HSV900 and dissolved in NMP. The prepared resin mixture solution was placed on the FEP container and dried on the convection oven at 120° C. for couple of hours. The dried and thick films were folded and pressed at 150° C. and 1000 pounds for 3 minutes followed by incremental increase of pressure up to 20000 pounds to form a rectangular shape of 0.25 inch, 2 inch and 2 inch size. Prepared blended resin was dried further under house vacuum at 50° C. for overnight. About 1 g of each sample was placed inside of the vials with a flexible cap with addition of enough volume of standard electrolyte (Novolyte® 1M LiPF₆ 70-30 EMC-EC) to submerge the resin sample completely. The vials were placed on the heating block at 70° C. for 4 days. Swelling of the binder system was measured by checking weight changes (Table 10). Swell index is the ratio of weight of the swelled polymer to that of the dried polymer. All three ECP resins completely dissipated in the standard electrolytes when tested without PVDF.

TABLE 10
Electrolyte Resistance of ECP resin modified PVDF

| | Sample Weight (g) | | | | |
|---|---|---|---|---|---|
| | Raw | Swelled | Re-dried | % change | Swell index |
| ECP-1 modified | 1.223 | 1.846 | 1.191 | −2.63 | 1.51 |
| ECP-2 modified | 1.334 | 1.953 | 1.310 | −1.81 | 1.46 |
| ECP-3 modified | 1.269 | 2.082 | 1.253 | −1.29 | 1.64 |
| unmodified | 0.983 | 1.230 | 1.033 | 5.10 | 1.25 |

1. A blend composition comprising
(a) an ethylene copolymer comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof wherein the polymer contains copolymerized units of 2 to 80 weight % of the comonomer; and
(b) a halogenated (co)polymer.

2. The composition of claim 1 wherein the ethylene copolymer comprises from about 1 to about 80 weight % of the combination of (a) and (b).

3. The composition of claim 1 wherein the ethylene copolymer comprises from about 5 to about 80 weight % of the combination of (a) and (b).

4. The composition of claim 1 wherein the ethylene copolymer comprises from about 15 to about 80 weight % of the combination of (a) and (b).

5. The composition of claim 1 wherein (b) comprises polyvinyl chloride, polyvinylidene chloride, polytetrafluoroethylene, polyvinylidene fluoride (PVDF), tetrafluoroethylene-hexafluoropropylene copolymers, vinylidene fluoride-hexafluoropropylene copolymers (PVDF-HFP), vinylidene fluoride-tetrafluoroethylene copolymers, tetrafluoroethylene-hexafluoropropylene-vinylidene fluoride terpolymers (THV), tetrafluoroethylene-hexafluoropropylene-vinyl fluoride terpolymers, tetrafluoroethylene-hexafluoropropylene-vinylfluoride terpolymers, vinylidene fluoride-chlorotrifluoroethylene copolymers, ethylene-chlorofluoroethylene copolymers, polyvinyl fluoride (PVF), perfluoroalkoxy polymer resin (PFA), fluorinated ethylene propylene (FEP), poly(ethylene-co-tetrafluoroethylene) (ETFE), polytetrafluoroethylene (PTFE) or combination thereof.

6. The composition of claim 1 wherein (b) comprises polyvinylidene fluoride, polyvinyl fluoride, perfluoroalkoxy polymer resin, fluorinated ethylene propylene, poly(ethylene-co-tetrafluoroethylene), tetrafluoroethylene-hexafluoropropylene-vinylidene fluoride terpolymer, tetrafluoroethylene-hexafluoropropylene-vinyl fluoride terpolymer, vinylidene fluoride-hexafluoropropylene copolymer, polytetrafluoroethylene or vinylidene fluoride-tetrafluoroethylene copolymer or combination thereof.

7. The composition of claim 1 wherein (b) comprises polyvinylidene fluoride.

8. The composition of claim 1 wherein the comonomer comprises a derivative of an α,β-unsaturated monocarboxylic acid.

9. The composition of claim 8 wherein the comonomer is an alkyl methacrylate, an alkyl acrylate, or combinations thereof.

10. The composition of claim 1 wherein the ethylene copolymer is an ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof.

11. The composition of claim 1 wherein the ethylene copolymer is an elastomer derived from copolymerization of
(a) from 13 to 50 weight % of ethylene;
(b) from 50 to 80 weight % of an alkyl acrylate; and
(c) from 0 to 7 weight % of a monoalkyl ester of 1,4-butene-dioic acid, wherein all weight percentages are based on total weight of components (a) through (c) in the copolymer and the percentages of (a), (b) and (c) total 100%.

12. The composition of claim 1 further comprising a curing agent.

13. The composition of claim 12 wherein the curing agent comprises trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, pyromellitic anhydride, benzophenone tetracarboxylic anhydride, ethylene glycol bistrimellitate, glycerol tristrimellitate, alkylstyrene-maleic anhydride copolymer, polyazelaic polyanhydride, polyetheramine, 1,2,4-benzenetricarboxylic anhydride, bisphenol A, bisphenol A ester, bisphenol A diglycidyl ether, trimethylolpropane tris[poly(propylene glycol), amine terminated]ether, polyamide made from fatty dimer acid, polyamine, triethylenediamine, 2,4,6-tris(dimethylaminomethyl)phenol, liquid polymercaptan, polysulfide resin, a carbodiimide or a derivative thereof, an isocyanide or a derivative thereof, or combinations of two or more thereof.

14. The composition of claim 12 wherein the curing agent comprises a diamine, diepoxide, dianhydride, carbodiimide, isocyanide, polyamine, polyepoxide or polyanhydride.

15. The composition of claim 1 wherein the ethylene copolymer is crosslinked.

16. The composition of claim 1 further comprising a metal oxide, mixed metal oxide, metal phosphate, metal salt, or combinations of two or more thereof, and optionally an electrical conductivity aid.

17. A method for preparing the blend composition of claim 1 comprising
(1) preparing a mixture comprising an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer, and an organic solvent;
(2) preparing a mixture comprising a halogenated (co)polymer and an organic solvent;
(3) combining the mixture comprising the ethylene copolymer and the mixture comprising the halogenated (co)polymer.

18. The method of claim 17 wherein the solvents comprise diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane, decaline, acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N,N-dimethyl acetamide, N,N-diethyl acetamide or combinations thereof.

19. The method of claim 18 wherein the solvents comprise ethyl acetate or N-methyl-2-pyrrolidone.

20. The method of claim 17 further comprising mixing the blend composition with a metal oxide, mixed metal oxide, metal phosphate, metal salt, or combinations of two or more thereof, and optionally an electrical conductivity aid.

21. An electrochemical cell comprising the composition of claim 1.

22. The electrochemical cell of claim 21 comprising a negative electrode (anode), a positive electrode (cathode), an electrolyte and a separator, preferably wherein the positive electrode comprises a binder composition and a cathode active material wherein the binder composition is as characterized in claim 1; and the cathode active material comprises a lithiated transition metal oxide or lithiated transition metal phosphate, or combinations thereof.

23. The electrochemical cell of claim 21 wherein the anode active material comprises carbon, lithium titanate, Si, Sn, Sb, or alloys or precursors to lithium alloys with Si, Sn, or Sb.

24. A lithium ion battery electrode comprising a binder composition and a cathode active material wherein the binder composition is as characterized in claim 1; and the cathode active material comprises a lithiated transition metal oxide or lithiated transition metal phosphate, or combinations thereof.

25. A lithium ion battery electrode comprising a binder composition and an anode active material wherein the binder composition is as characterized in claim 1; and the anode active material comprises carbon, lithium titanate, Si, Sn, Sb, or alloys or precursors to lithium alloys with Si, Sn, or Sb.
